(19) United States
(12) Patent Application Publication
(10) Pub. No.: US 2011/0145519 A1
(43) Pub. Date: Jun. 16, 2011

(54) DATA WRITING APPARATUS AND DATA WRITING METHOD

(75) Inventor: Katsuki Uwatoko, Tachikawa-shi (JP)

(73) Assignee: KABUSHIKI KAISHA TOSHIBA, Tokyo (JP)

(21) Appl. No.: 12/950,738

(22) Filed: Nov. 19, 2010

(30) Foreign Application Priority Data
Dec. 14, 2009 (JP) 2009-283167

(51) Int. Cl. G06F 12/00

(52) U.S. Cl. 711/154; 711/E12.001

(57) ABSTRACT

According to one embodiment, a data writing apparatus includes a memory and write module. The memory includes a storage area including a physical block having a data area and redundancy area. The write module is configured to write a data block obtained by dividing data, in the data area of the physical block. In addition, the write module is configured to write a first data block in a first data area which is the data area of a first physical block, write a second data block as a data block to be read before the first data block when reading the data, in a second data area which is the data area of a second physical block, and write information indicating the first physical block in the redundancy area of the second physical block.

### CROSS-REFERENCE TO RELATED APPLICATIONS

This application is based upon and claims the benefit of priority from Japanese Patent Application No. 2009-283167, filed Dec. 14, 2009; the entire contents of which are incorporated herein by reference.

### BACKGROUND

1. Field

Embodiments described herein relate generally to a data writing apparatus and data writing method of writing data such as a program in, e.g., a NAND flash memory.

2. Related Art

A personal computer is a typical apparatus controlled by a central processing unit (CPU). Recently, as digital video apparatuses have become popular, CPUs also control the operations of digital TV sets, hard disk recorders, and the like. A CPU records a program in a normal data storage area except for defective areas on a nonvolatile memory, and reads a program from a normal data storage area.

As described above, to accurately read data from a normal data storage area except for defective areas, defective areas on a nonvolatile memory must correctly be managed, and various methods of managing defective areas on a nonvolatile memory have been proposed. Jpn. Pat. Appln. KOKAI Publication No. 10-240627 has disclosed the following technique. For example, all sectors #0 to #63 are used as data storage sectors, and a pointer indicating the connection to another sector is stored in each of byte areas B0-n to B63-n at the ends of the sectors #0 to #63. If a sector to be connected next exists, the number of the sector to be connected next is stored as the pointer. If no sector to be connected next exists, “0” is stored as the pointer. Even when a write error occurs during data write, therefore, it is possible to access a data storage area storing data irrelevant to data having the write error. This technique can also simplify a pointer operation during data read.

When the pointer indicating the connection to another sector is recorded in the area at the end of each sector as described above, an event may occur in which, for example, although a pointer indicating the connection to the second sector is recorded in the area at the end of the first sector, data cannot correctly be written in the second sector. If an event like this occurs, it is necessary to, e.g., correct the pointer recorded in the area at the end of the first sector. This decreases the data recording efficiency of the writing process.

### BRIEF DESCRIPTION OF THE DRAWINGS

A general architecture that implements various features of the embodiments will now be described with reference to the drawings. The drawings and the associated descriptions are provided to illustrate the embodiments and not to limit the scope of the invention.

FIG. 1 is an exemplary view showing an example of an outline of the arrangement of a program execution apparatus (data writing apparatus) according to an embodiment;

FIG. 2 is an exemplary view showing an example of the process of loading a program (e.g., an activation program) according to an embodiment;

FIG. 3 is a view showing a first example of a process of writing a program (e.g., an activation program) according to an embodiment;

FIG. 4 is a view showing a second example of a process of writing the last data block according to an embodiment;

FIG. 5 is a flowchart showing an example of a process of loading a program (e.g., an activation program) according to an embodiment; and

FIG. 6 is a flowchart showing an example of a process of writing a program (e.g., an activation program) according to an embodiment.

### DETAILED DESCRIPTION

Various embodiments will be described hereinafter with reference to the accompanying drawings.

In general, according to one embodiment, a data writing apparatus includes a memory and write module. The memory includes a storage area including a physical block having a data area and redundancy area. The write module is configured to write a data block obtained by dividing data, in the data area of the physical block. In addition, the write module is configured to write a first data block in a first data area which is the data area of a first physical block, write a second data block as a data block to be read before the first data block when reading the data, in a second data area which is the data area of a second physical block, and write information indicating the first physical block in the redundancy area of the second physical block.

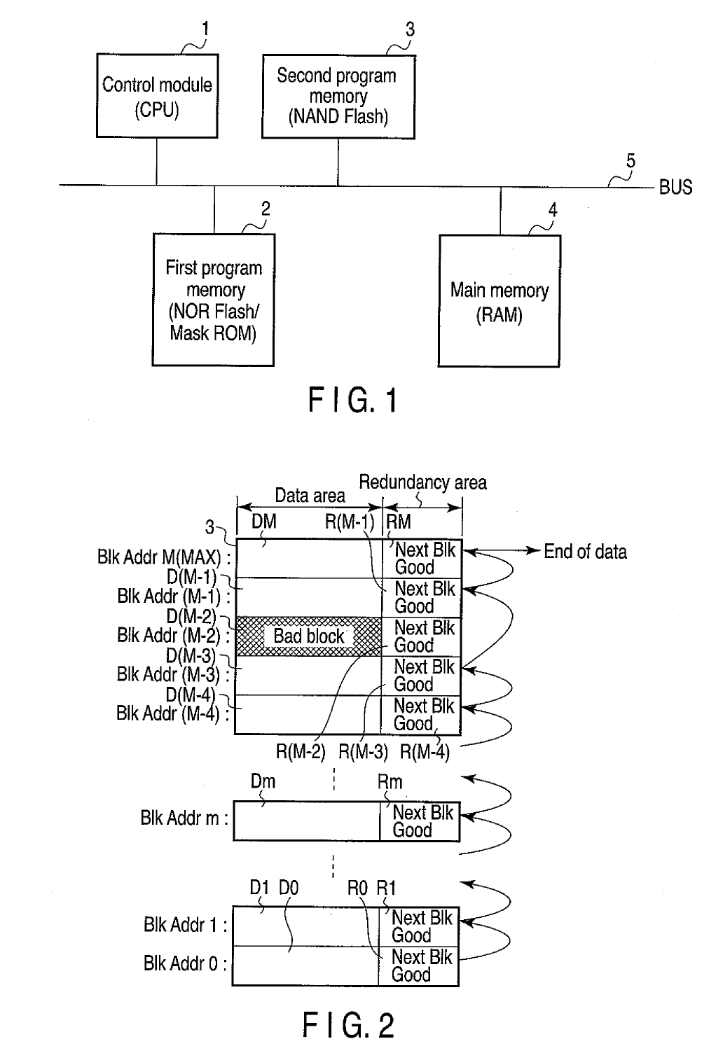

FIG. 1 is an exemplary view showing an outline of the arrangement of a program execution apparatus or program execution system (i.e., the data writing apparatus) according to the embodiment. This program execution apparatus or program execution system (to be referred to as a program execution apparatus hereinafter) is applicable to, e.g., a personal computer, digital TV set, or hard disk recorder.

As shown in FIG. 1, the program execution apparatus includes a control module 1 that can be a CPU or the like, a first program memory 2 that is, e.g., a NOR flash memory or mask read-only memory (ROM), a second program memory 3 that can be a NAND flash memory or the like, and a main memory 4 that can be a random access memory (RAM) or the like. A bus 5 connects the control module 1, first program memory 2, second program memory 3, and main memory 4.

When this program execution apparatus is turned on, the control module 1 directly executes a program on the first program memory 2, and loads a program on the second program memory 3 to the main memory 4. In this embodiment, the process of writing a program in the second program memory 3 and the process of loading a program written in the second program memory 3 will be explained.

To simplify the explanation, assume that, as shown in FIG. 2, the second program memory 3 has a storage area including M (3≦M, M: natural number) blocks. The control module 1 sequentially reads a plurality of data blocks from physical blocks B0 to BM included in the storage area. When writing a program later, therefore, the control module 1 sequentially writes a plurality of data blocks in physical blocks BM to B0. The plurality of data blocks are generated by dividing the program into a plurality of portions.

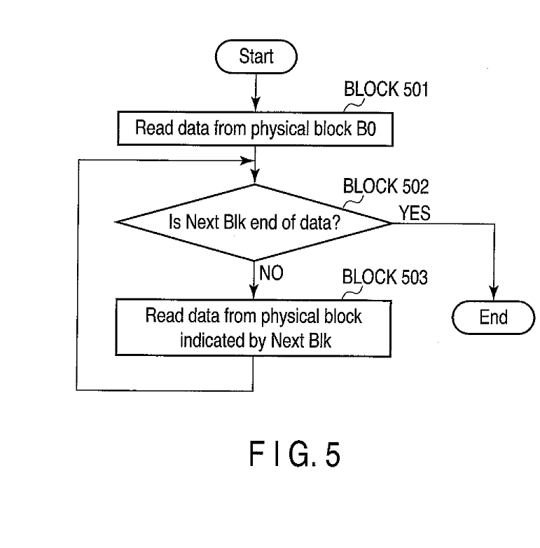

FIG. 2 is a conceptual view showing an example of the process of loading a program (e.g., an activation program) written in the second program memory 3. FIG. 5 is a flowchart showing an example of the process of loading a program (e.g., an activation program) written in the second program memory 3.

For example, the second program memory 3 includes physical block B0 at block address 0 (to be abbreviated as Blk Addr 0 hereinafter), physical block B1 at Blk Addr 1, physical block B2 at Blk Addr 2, . . . , physical block Bm at Blk Addr m, physical block B(M−4) at Blk Addr (M−4), physical block B(M−3) at Blk Addr (M−3), physical block B(M−2) at Blk Addr (M−2), physical block B(M−1) at Blk Addr (M−1), and physical block BM at Blk Addr M.

Each physical block includes a data area and redundancy area. That is, physical block B0 includes a data area D0 and redundancy area R0, physical block B1 includes a data area D1 and redundancy area R1, physical block B2 includes a data area D2 and redundancy area R2, . . . , physical block Bm includes a data area Dm and redundancy area Rm, physical block B(M−4) includes a data area D(M−4) and redundancy area R(M−4), physical block B(M−3) includes a data area D(M−3) and redundancy area R(M−3), physical block B(M−2) includes a data area D(M−2) and redundancy area R(M−2), physical block B(M−1) includes a data area D(M−1) and redundancy area R(M−1), and physical block BM includes a data area DM and redundancy area RM.

First, the control module 1 reads data from physical block B0 at Blk Addr 0 (BLOCK 501). Note that although the operation of initially reading data from physical block B0 at Blk Addr 0 will be explained in this embodiment, it is also possible to initially read data from a physical block at an address other than Blk Addr 0.

The control module 1 reads management information for managing data area D0, which is written in redundancy area R0 included in physical block B0 at Blk Addr 0. This management information contains, e.g., information indicating a physical block as the next read target after the control module 1 has read data from physical block B0, and information indicating whether physical block B0 at Blk Addr 0 is a bad block. For example, if the management information written in redundancy area R0 is next physical block information (Next Blk) indicating the next read target (NO in BLOCK 502), and the next physical block information indicates Blk Addr 1, the control module 1 subsequently reads data from physical block B1 at Blk Addr 1 (BLOCK 503). In addition, if management information (next physical block information) written in redundancy area R1 included in physical block B1 indicates Blk Addr 2 (NO in BLOCK 502), the control module 1 subsequently reads data from physical block B2 at Blk Addr 2 (BLOCK 503). Thus, the control module 1 sequentially reads data from the physical blocks, depending on the management information (next physical block information) written in the redundancy areas. The next physical block information herein mentioned is information indicating the next physical block, and means address information of a physical block in this embodiment. However, this is merely an example, and the embodiment is not limited to this. That is, the next physical block information can also be indicated by, e.g., offset information with respect to the next physical block.

For example, if management information (next physical block information) written in redundancy area R(M−3) included in physical block B(M−3) indicates Blk Addr (M−1) (NO in BLOCK 502), the control module 1 reads data from physical block B(M−1) at Blk Addr (M−1) (BLOCK 503). For example, if physical block B(M−2) is a bad block, the control module 1 can read data from physical block B(M−1) by skipping physical block B(M−2). In addition, if the management information (next physical block information) written in redundancy area R(M−3) included in physical block B(M−3) indicates Blk Addr (M−1), the control module 1 can read data from physical block B(M−1) by skipping physical block B(M−2), even when the management information written in redundancy area R(M−2) included in physical block B(M−2) does not contain a bad block mark as information indicating that the corresponding physical block is a bad block.

If the management information (next physical block information) written in redundancy area R(M−1) included in physical block B(M−1) indicates Blk Addr M (NO in BLOCK 502), the control module 1 reads data from physical block BM at Blk Addr M (BLOCK 503). The control module 1 continues the reading process until information indicating the end of data is read from the redundancy area. For example, if management information written in redundancy area RM included in physical block BM is not the next physical block information but the information indicating the end of data (YES in BLOCK 502), the control module 1 terminates the series of data reading processes.

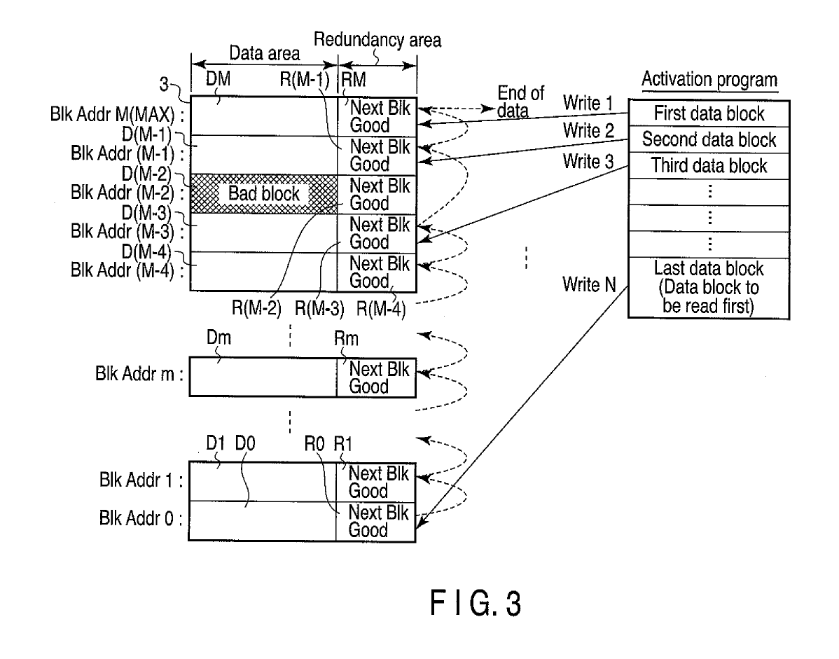

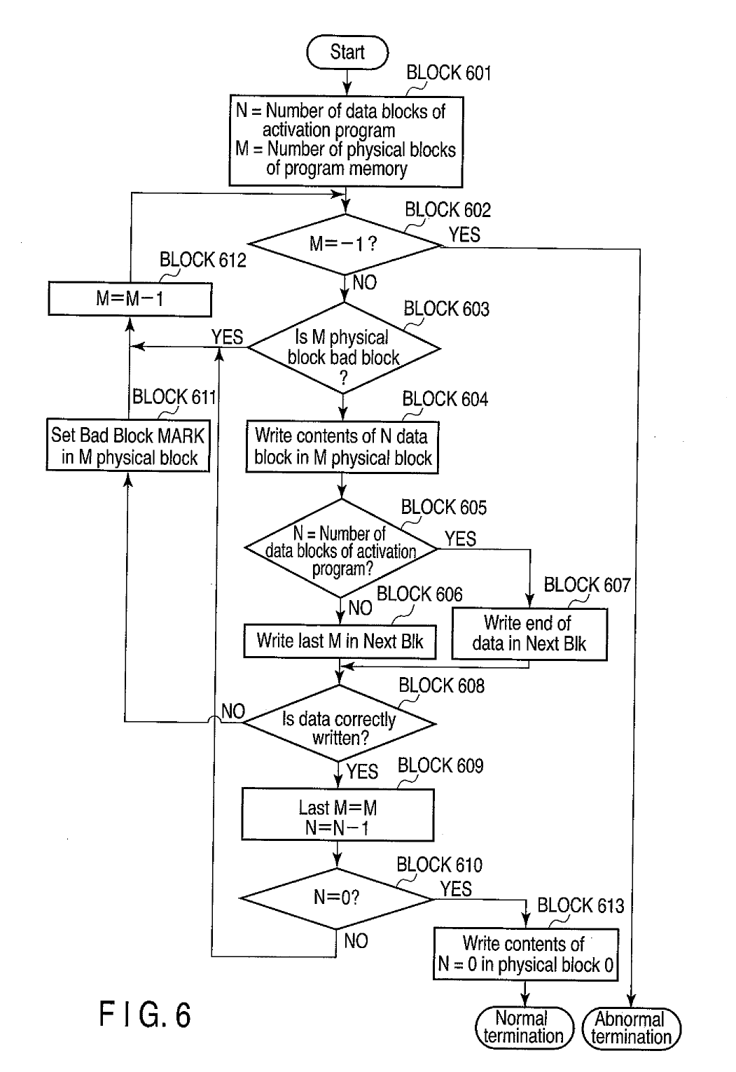

FIG. 3 is a conceptual view showing an example of the process of writing a program (e.g., an activation program) in the second program memory 3. FIG. 6 is a flowchart showing an example of the process of writing a program (e.g., an activation program) in the second program memory 3.

As shown in FIG. 3, the activation program is divided in accordance with the size of each block constructing the second program memory 3, thereby generating a plurality of (N) data blocks. That is, the plurality of (N) data blocks are generated by dividing the activation program in accordance with the size of the data area of each physical block, and written in the plurality of (M) physical blocks (BLOCK 601).

The control module 1 writes the plurality of (N) data blocks generated from the activation program in the order of physical blocks BM to B0. Note that in this embodiment, the operation of writing the data blocks from the last physical block BM will be explained. However, this embodiment is not limited to the operation of writing the data blocks from the last physical block BM, provided that the data blocks are written from a physical block other than a physical block from which data is initially read.

First, if physical block BM at Blk Addr M is not a bad block (NO in BLOCK 602) (NO in BLOCK 603), the control module 1 writes a first data block (Nth data block) in data area DM included in physical block BM (BLOCK 604), and writes management information (information indicating the end of data) in redundancy area RM included in physical block BM (YES in BLOCK 605) (BLOCK 607). Note that the first data block (Nth data block) is a data block to be read last.

If the data is correctly written in physical block BM (YES in BLOCK 608), the control module 1 holds information indicating that the data is correctly written at Blk Addr M (=Last M), and advances to the process of writing a second data block ((N−1)th data block) in physical block B(M−1) at Blk Addr (M−1) (BLOCK 609) (NO in BLOCK 610) (BLOCK 612).

If physical block B(M−1) at Blk Addr (M−1) is not a bad block (NO in BLOCK 602) (NO in BLOCK 603), the control module 1 writes the second data block ((N−1)th data block) in data area D(M−1) included in physical block B(M−1) (BLOCK 604), and writes management information (next physical block information (Next Blk) indicating the next read target) in redundancy area R(M−1) included in physical block B(M−1) (NO in BLOCK 605) (BLOCK 606). In this case, Blk Addr M is written as the management information.

If the data is correctly written in physical block B(M−1) (YES in BLOCK 608), the control module 1 holds information indicating that the data is correctly written at Blk Addr (M−1), and advances to the process of writing a third data block ((N−2)th data block) in physical block B(M−2) at Blk Addr (M−2) (BLOCK 609) (NO in BLOCK 610) (BLOCK 612).

For example, if physical block B(M−2) is a bad block (NO in BLOCK 602) (YES in BLOCK 603), the control module 1 advances to the process of writing the third data block ((N−2)th data block) in physical block B(M−3) at Blk Addr (M−3) (BLOCK 612). On the other hand, if the data is unsuccessfully written in physical block B(M−2) (NO in BLOCK 608), the control module 1 writes management information (Bad Block MARK) in redundancy area R(M−2) included in physical block B(M−2) (BLOCK 611), and advances to the process of writing the third data block ((N−2)th data block) in physical block B(M−3) at Blk Addr (M−3) (BLOCK 612).

Subsequently, if physical block B(M−3) at Blk Addr (M−3) is not a bad block (NO in BLOCK 602) (NO in BLOCK 603), the control module 1 writes the third data block ((N−2)th data block) in data area D(M−3) included in physical block B(M−3) (BLOCK 604), and writes management information (next physical block information (Next Blk) indicating the next read target) in redundancy area R(M−3) included in physical block B(M−3) (NO in BLOCK 605) (BLOCK 606). In this case, Blk Addr (M−1) is written as the management information.

As described above, the control module 1 writes data in physical blocks one after another by skipping defective blocks.

Finally, the control module 1 writes the last data block as a data block to be written last among the plurality of (N) data blocks, in data area D0 included in physical block B0 at Blk Addr 0, and writes management information (next physical block information (Next Blk) indicating the next read target) in redundancy area R0 included in physical block B0 (BLOCK 613). Note that the last data block is data to be read first.

Note that although an explanation concerning the erase of written data is omitted from the above explanation, the control module 1 erases written data from each physical block and then writes data in the physical block. For example, the control module 1 erases written data from data area DM included in physical block BM, and then writes the first data block in data area DM. Similarly, the control module 1 erases written data from redundancy area RM included in physical block BM, and then writes the management information in redundancy area RM.

As described above, the data blocks are written in the reverse order of the read order (FIGS. 2 and 5). The operation of writing the data blocks in the same order as the read order will be described below as an example. Assume that a data block is written in a certain physical block Bm, and management information (next block information indicating physical block B(m+1) as the next read target) is written in a redundancy area Rm of physical block Bm. If physical block B(m+1) as the next write target (i.e., the next read target) is a bad block, no data block can correctly be written in physical block B(m+1). Therefore, the management information written in redundancy area Rm of physical block Bm as the next read target is incorrect information, and this decreases the data reliability.

To eliminate this mismatching of the management information, the management information must be rewritten as follows. Assume that, as described above, after a data block is written in physical block Bm, the next data block cannot be written in physical block B(m+1) but can be written in physical block B(m+2). In this case, incorrect management information (next block information indicating physical block B(m+1) as the next read target) is written in redundancy area Rm of physical block Bm. Therefore, this incorrect management information (next block information indicating physical block B(m+1) as the next read target) must be written with correct management information (next block information indicating physical block B(m+2) as the next read target). The processing efficiency decreases if this processing is performed. In addition, when rewriting an internal redundancy area of a physical block in a storage medium such as a NAND flash memory, data is erased for each physical block. Accordingly, it is necessary to erase data correctly written in a data area, and rewrite the data. This decreases the efficiency of the whole writing process.

When writing data blocks in the same order as the read order as described above, the data reliability decreases if write target physical blocks include a bad block. In addition, the processing efficiency decreases because it is necessary to perform processing that eliminates this problem.

In this embodiment, data blocks are written in the reverse order of the read order (FIGS. 2 and 5). Therefore, after a data block can correctly be written in physical block BM, the management information (Blk Addr M indicating the next read target) is written in redundancy area R(M−1) included in physical block B(M−1). Accordingly, even when a bad block exists among write target physical blocks, the management information need not be rewritten. In the above-described writing process, therefore, data can efficiently be written by avoiding defective areas without decreasing the data reliability.

It is also possible to write data as follows in order to write the data in the same order as the read order (FIGS. 2 and 5), and prevent the rewrite of management information.

First, the control module 1 writes the last data block (a data block to be read first) in data area D0 included in physical block B0 at Blk Addr 0. Then, the control module 1 writes the subsequent data block in data area D1 included in physical block B1 at Blk Addr 1. After confirming that the subsequent data block is successfully written in data area D1, the control module 1 writes management information (Blk Addr 1 indicating the next read target) in redundancy area R0 included in physical block B0.

Assume that the control module 1 writes a data block in data area D(M−3) included in physical block B(M−3) at Blk Addr (M−3), and subsequently writes a data block in data area D(M−2) included in physical block B(M−2) at Blk Addr (M−2). If this data block is unsuccessfully written in data area D(M−2), the control module 1 writes the data block in the data area D(M−1) included in physical block B(M−1) at Blk Addr (M−1). If the data block is successfully written in data area D(M−1), the control module 1 writes management information (Blk Addr (M−1) indicating the next read target) in redundancy area R(M−3) included in physical block B(M−3).

The above processing can prevent the rewrite of management information even when data is written in the same order as the read order (FIGS. 2 and 5).

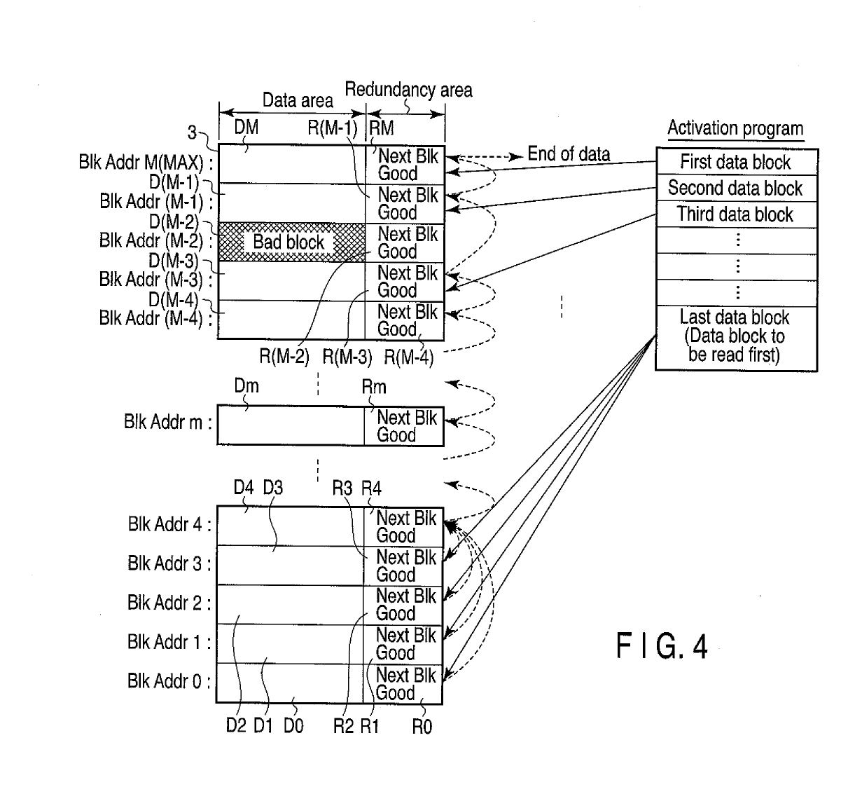

FIG. 4 is a conceptual view showing another example of the process of writing the last data block in the second program memory 3.

When it is determined to start data read from physical block B0 at Blk Addr 0, it is difficult for the control module 1 to correctly load data from the second program memory if physical block B0 is a bad block or data is unsuccessfully written in physical block B0.

As shown in FIG. 4, therefore, the last data block is written in two or more physical blocks. In this writing process example, the operation of writing the last data block in four physical blocks will be explained.

For example, when data is correctly written in physical block B4 at Blk Addr 4, the control module 1 writes the last data block in data area D3 included in physical block B3 at Blk Addr 3, and writes management information (next physical block information (Next Blk) indicating the next read target) in redundancy area R3 included in physical block B3. In this case, Blk Addr 4 is written as the management information.

In addition, the control module 1 writes the last data block in data area D2 included in physical block B2 at Blk Addr 2, and writes management information (next physical block information (Next Blk) indicating the next read target) in redundancy area R2 included in physical block B2. Blk Addr 4 is written as the management information in this case as well.

Also, the control module 1 writes the last data block in data area D1 included in physical block B1 at Blk Addr 1, and writes management information (next physical block information (Next Blk) indicating the next read target) in redundancy area R1 included in physical block B1. Blk Addr 4 is written as the management information in this case as well.

Furthermore, the control module 1 writes the last data block in data area D0 included in physical block B0 at Blk Addr 0, and writes management information (next physical block information (Next Blk) indicating the next read target) in redundancy area R0 included in physical block B0. Blk Addr 4 is written as the management information in this case as well.

Thus, the control module 1 redundantly writes the last data block. In a read operation, the control module 1 compares data D0, D1, D2, and D3 read from physical blocks B0, B1, B2, and B3, and selects data having the highest reliability from data D0, D1, D2, and D3. For example, the control module 1 selects data having the highest reliability by using a majority decision. If data D0 and D1 are practically the same, data D2 is not practically the same as any of data D0, D1, and D3, and data D3 is not practically the same as any of data D0, D1, and D2, the control module 1 can select data D0 or D1 as data having the highest reliability. This makes it possible to prevent a read error or the like.

As described above, the program execution apparatus of this embodiment writes the management information (next physical block information) in the redundancy area of each physical block of a NAND flash memory. This obviates the need to read data from all physical blocks of the NAND flash memory (the need to form any address conversion table), in order to make virtual addresses and physical addresses of the NAND flash memory correspond to each other (in order to convert the physical addresses into logical addresses). This makes high-speed activation possible (makes high-speed read of an activation program possible).

Also, even when a block incapable of data write exists among a plurality of physical blocks constructing a NAND flash memory, i.e., even when an unwritable block in which even a bad block mark cannot be written exists, data can be read from only normal blocks by skipping the unwritable block, depending on the management information (next physical block information) written in the redundancy area of each normal block. That is, an activation program can correctly be read even when an unwritable block exists among a plurality of physical blocks constructing a NAND flash memory.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data writing apparatus comprising:
a memory comprising a storage area comprising a first physical block and a second physical block, each comprising a data area and a redundancy area; and
a write module configured to write first and second data blocks, obtained by dividing data, in the respective data areas of the first and the second physical blocks,
wherein the write module is configured to write a first data block in the data area of the first physical block, to write a second data block in the data area of the second physical block as a data block to be read before the first data block when reading the data, and to write information indicating the first physical block in the redundancy area of the second physical block.

2. The apparatus of claim 1, wherein the write module is configured to, when the second physical block is not a normal block and a third physical block is a normal block, write the second data block in a data area of a third physical block instead of writing the second data block in the data area of the second physical block, and write information indicating the first physical block in a redundancy area of the third physical block.

3. The apparatus of claim 1, wherein the write module is configured to erase data written in a physical block as a write target before writing a data block in the physical block, and then write a data block in the physical block as a write target.

4. The apparatus of claim 1, wherein the write module is configured to write information indicating that the first data block is a data block to be read last among the data blocks of the data, in the redundancy area of the first physical block, when the first data block is a data block to be read last among the data blocks of the data.

5. The apparatus of claim 1, wherein the write module is configured to write a third data block to be read first among the data blocks of the data in the data areas of a plurality of physical blocks, and to write information indicating a fourth physical block as a next read target in the redundancy areas of the plurality of physical blocks.

6. The apparatus of claim 1, wherein the write module is configured to write information indicating the first physical block in the redundancy area of the second physical block after writing the first data block in the data area of the first physical block.

7. The apparatus of claim 1, wherein the write module is configured to write an address of the first physical block as the information indicating the first physical block, which is to be written in the redundancy area of the second physical block.

8. A data writing method of writing data blocks, obtained by dividing data, in data areas of a storage medium that comprises a storage area comprising first and second physical blocks each having a data area and a redundancy area, the method comprising:
writing a first data block in the data area of the first physical block;
writing a second data block in the data area of the second physical block as a data block to be read before the first data block when reading the data; and
writing information indicating the first physical block in the redundancy area of the second physical block.
